(19) United States
(12) Patent Application Publication
(10) Pub. No.: US 2009/0063161 A1
(43) Pub. Date: Mar. 5, 2009

(54) METHOD AND APPARATUS FOR ENCODING AND DECODING CONTINUATION SINUSOIDAL SIGNAL OF AUDIO SIGNAL

(75) Inventors: Nam-suk Lee, Suwon-si (KR); Geon-hyoung Lee, Hwaseong-si (KR); Jong-hoon Jeong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/167,578

(22) Filed: Jul. 3, 2008

(30) Foreign Application Priority Data
Aug. 28, 2007 (KR) 10-2007-0086548

(51) Int. Cl. G10L 19/00

(52) U.S. Cl. 704/500; 704/E19.001

(57) ABSTRACT

Provided are an audio signal encoding method and apparatus that encode a continuation sinusoidal signal of a current frame in different ways according to information on a sinusoidal signal of a previous frame by using the characteristics of the continuation sinusoidal signal, and an audio signal decoding method and apparatus. The audio signal encoding method includes extracting a sinusoidal signal of a current frame by performing sinusoidal analysis on an input audio signal; extracting a continuation sinusoidal signal of the current frame, which is connected to a sinusoidal signal of a previous frame, by performing sinusoidal tracking of the extracted sinusoidal signal of the current frame; and encoding the continuation sinusoidal signal in different ways by using information on the sinusoidal signal of the previous frame, which is connected to the continuation sinusoidal signal.

### CROSS-REFERENCE TO RELATED PATENT APPLICATION

This application claims priority from Korean Patent Application No. 10-2007-0086548, filed on Aug. 28, 2007, in the Korean Intellectual Property Office, the disclosure of which is incorporated herein in its entirety by reference.

### BACKGROUND OF THE INVENTION

1. Field of the Invention

The present invention relates to encoding and decoding of an audio signal, and more particularly, to a method and apparatus for encoding an audio signal that encode a continuation sinusoidal signal in different ways by using information of a sinusoidal signal of a previous frame, which is connected to the continuation sinusoidal signal in a current frame of the audio signal including the continuation sinusoidal signal, and a method and apparatus for decoding the audio signal.

2. Description of the Related Art

An audio encoding method described in the present invention is applied to parametric coding. Parametric coding is a coding method of representing audio as specific parameters. Parametric coding is used in the MPEG-4 (Moving Picture Experts Group 4) standard.

FIG. 1 is a block diagram for describing a parametric coding method. Referring to FIG. 1, in the parametric coding method, an input signal is analyzed and parameterized. Specifically, an input audio signal is filtered (by performing audio reading and filtering). By analyzing the input audio signal by using three analysis methods, which are transient analysis 120, sinusoidal analysis 130, and noise analysis 140, parameters corresponding to audio components in respective areas are extracted.

The transient analysis 120 corresponds to a change of very dynamic audio. The sinusoidal analysis 130 corresponds to a change of deterministic audio. The noise analysis 140 corresponds to a change of stochastic or non-deterministic audio.

The extracted parameters are formatted as a bitstream 150.

A sinusoid extracted by the sinusoidal analysis 130 is referred to as a partial.

FIG. 2 is a flowchart illustrating a related art parametric coding process. Referring to FIG. 2, if an audio signal is input, a sinusoid is extracted from a current frame by performing sinusoidal analysis in operation 210.

The extracted sinusoid is connected to a sinusoid of a previous frame, which is similar to the sinusoid of the current frame, by performing sinusoidal tracking in operation 220.

As will be described later, the sinusoid of the current frame, which is continuous to the sinusoid of the previous frame, is referred to as a continuation sinusoid.

The extracted sinusoid is quantized in operation 230. Quantization is a process for dividing a signal value at predetermined intervals. Specifically, the size of a waveform is presented at several predetermined stages in an analog to digital conversion (ADC) process for converting an analog waveform into a digital code.

The quantized sinusoid is finally entropy coded and is output as a bitstream in operation 240.

The related art parametric coding process uses a specific entropy coding process to encode a component value of a current frame to be encoded.

### SUMMARY OF THE INVENTION

Exemplary embodiments of the present invention provide a more efficient method of encoding an audio signal by using the parametric coding process described above. The efficient encoding method reduces a bit rate necessary for coding.

More particularly, exemplary embodiments of the present invention provide a method and apparatus for encoding an audio signal by analyzing information on a sinusoidal signal of a previous frame connected to a continuation sinusoidal signal of a current frame, which is continuous to the sinusoidal signal of the previous frame, among an extracted partial sinusoidal signal after sinusoidal analysis is performed, and a method and apparatus for decoding an encoded bitstream audio signal.

According to an aspect of the present invention, there is provided an audio signal encoding method comprising: extracting a sinusoidal signal of a current frame by performing sinusoidal analysis on an input audio signal; extracting a continuation sinusoidal signal of the current frame, which is connected to a sinusoidal signal of a previous frame, by performing sinusoidal tracking of the extracted sinusoidal signal of the current frame; and encoding the continuation sinusoidal signal by using information on the sinusoidal signal of the previous frame, which is connected to the continuation sinusoidal signal.

The encoding of the continuation sinusoidal signal may comprise: extracting an entropy component included in the sinusoidal signal of the previous frame, which is connected to the continuation sinusoidal signal; dividing a value of the extracted entropy component into a plurality of ranges and determining the divided value; and encoding the continuation sinusoidal signal of the current frame corresponding to the plurality of ranges according to a result of the determination.

A Huffman table or arithmetic coding is used to encode the continuation sinusoidal signal of the current frame, and wherein different Huffman tables or different arithmetic probability values are used according to the plurality of ranges.

The value of the extracted entropy component may be determined to be in the ranges of 0 and values other than 0 or in the ranges between −1 and 1 and values other than between −1 and 1, and the extracted entropy component may be a frequency, phase, or amplitude.

According to another aspect of the present invention, there is provided an audio signal encoding apparatus comprising: a sinusoidal analyzing unit performing sinusoidal analysis of an input audio signal and extracting a sinusoidal signal of a current frame; a sinusoidal tracking unit performing sinusoidal tracking of the extracted sinusoidal signal of the current frame and extracting a continuation sinusoidal signal of the current frame, which is connected to a sinusoidal signal of a previous frame; and a continuation sinusoidal coding unit encoding the continuation sinusoidal signal based on information on the sinusoidal signal of the previous frame, which is connected to the continuation sinusoidal signal.

The continuation sinusoidal coding unit may comprise: an entropy component extracting unit extracting an entropy component included in the sinusoidal signal of the previous frame, which is connected to the continuation sinusoidal signal; a determining unit dividing a value of the extracted entropy component into a plurality of ranges and determining the divided value; and an encoder coding the continuation sinusoidal signal of the current frame based on the plurality of ranges according to a result of the determination.

The encoder may encode the continuation sinusoidal signal of the current frame using a Huffman table or arithmetic coding, and wherein different Huffman tables or different arithmetic probability values are used according to the plurality of ranges.

The determining unit may determine the value of the extracted entropy component in the ranges of 0 and values other than 0 or in the ranges between −1 and 1 and values other than between −1 and 1.

According to another aspect of the present invention, there is provided a method of decoding an audio signal that is input as a bitstream comprising: determining whether the input bitstream includes a continuation sinusoidal signal of a current frame, which is connected to a sinusoidal signal of a previous frame; and when the input bitstream is determined to include the continuation sinusoidal signal, decoding the continuation sinusoidal signal based on information on a decoded sinusoidal signal of the previous frame, which is connected to the continuation sinusoidal signal.

The determining may comprise: extracting an entropy component included in the sinusoidal signal of the previous frame, which is connected to the continuation sinusoidal signal; dividing a value of the extracted entropy component into a plurality of ranges and determining the divided value; and decoding the continuation sinusoidal signal of the current frame based on the plurality of ranges according to a result of the determination.

A Huffman table or arithmetic coding may be used to decode the continuation sinusoidal signal of the current frame, and wherein different Huffman tables or different arithmetic probability values are used according to the plurality of ranges.

The value of the extracted entropy component may be determined to be in the ranges of 0 and values other than 0 or in the ranges between −1 and 1 and values other than between −1 and 1, and the extracted entropy component may be a frequency, phase, or amplitude.

According to another aspect of the present invention, there is provided an apparatus for decoding an audio signal that is input as a bitstream comprising: a continuation sinusoidal signal determining unit determining whether an input bitstream includes a continuation sinusoidal signal of a current frame, which is connected to a sinusoidal signal of a previous frame; and a continuation sinusoidal decoding unit, when the input bitstream is determined to include the continuation sinusoidal signal, decoding the continuation sinusoidal signal based on information on a decoded sinusoidal signal of the previous frame, which is connected to the continuation sinusoidal signal.

The continuation sinusoidal decoding unit may comprise: an entropy component extracting unit extracting an entropy component included in the sinusoidal signal of the previous frame, which is connected to the continuation sinusoidal signal; a determining unit dividing a value of the extracted entropy component into a plurality of ranges and determining the divided value; and a decoder decoding the continuation sinusoidal signal of the current frame based on the plurality of ranges according to a result of the determination.

The decoder may decode the continuation sinusoidal signal of the current frame using a Huffman table or arithmetic coding, wherein different Huffman tables or different arithmetic probability values are used according to the plurality of ranges.

The determining unit may determine the value of the extracted entropy component in the ranges of 0 and values other than 0 or in the ranges between −1 and 1 and values other than between −1 and 1.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram for explaining a parametric coding method;

FIG. 2 is a flowchart illustrating a related art parametric coding process;

FIG. 3 is a diagram for explaining a tracked sinusoidal signal according to an exemplary embodiment of the present invention;

FIGS. 4A and 4B are graphs illustrating a distribution probability of an entropy component in a continuation sinusoidal signal of a current frame based on information on a sinusoidal signal of a previous frame, which is connected to the sinusoidal signal of the current frame according to an exemplary embodiment of the present invention;

FIG. 5 is a flowchart illustrating an audio signal encoding method according to an exemplary embodiment of the present invention;

FIG. 6 is a flowchart illustrating an operation of encoding the continuation sinusoidal signal in different ways by performing operations from among operations included in the audio signal encoding method according to an exemplary embodiment of the present invention;

FIG. 7 is a table showing a gain in the number of bits compared to the related art when an audio signal encoding method is applied according to an exemplary embodiment of the present invention;

FIG. 8 is a block diagram of an audio signal encoding apparatus according to an exemplary embodiment of the present invention; and

FIG. 9 is a block diagram of an audio signal decoding apparatus according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those of ordinary skill in the art. Like reference numerals in the drawings denote like elements, and thus their description will be omitted.

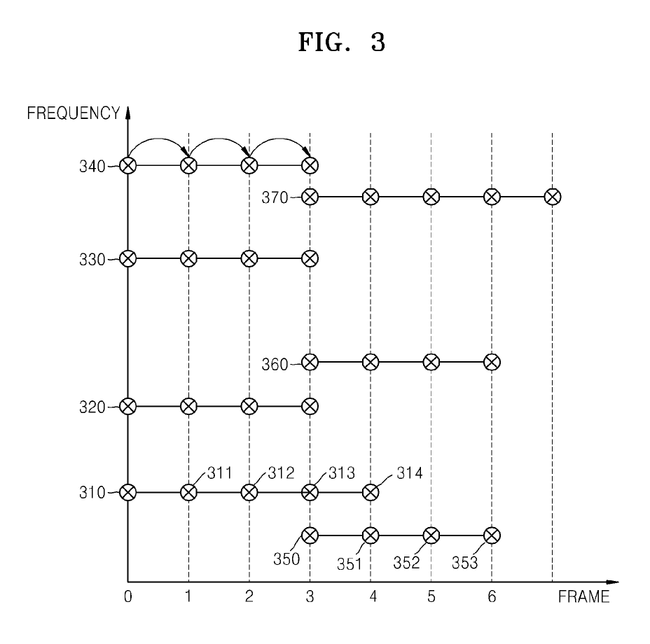

FIG. 3 is a diagram for explaining a tracked sinusoidal signal according to an exemplary embodiment of the present invention.

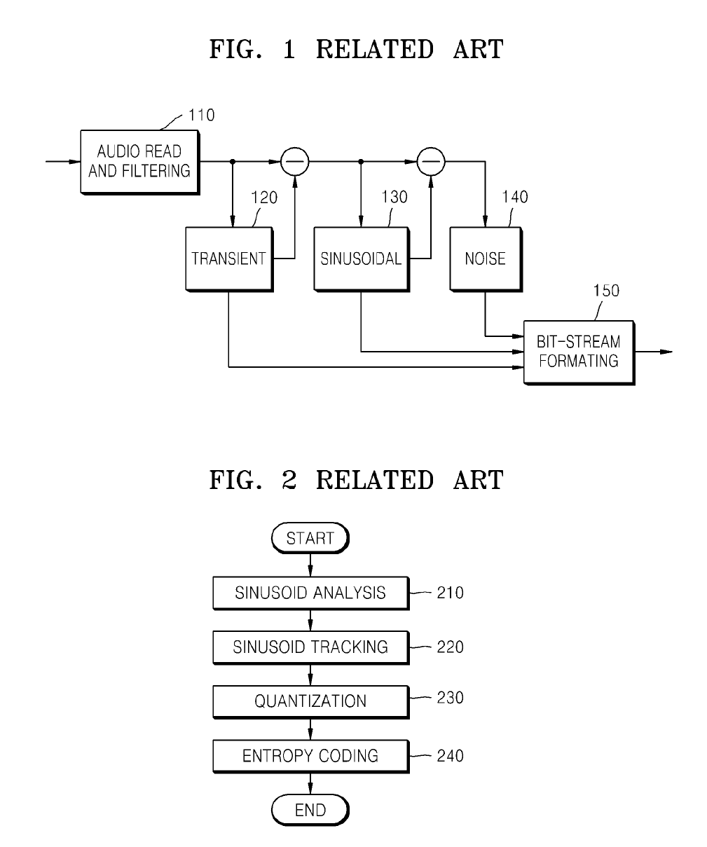

After sinusoidal analysis is performed as shown in FIG. 1, a sinusoidal signal is tracked in order to perform Adaptive Differential Pulse Code Modulation (ADPCM) or Differential Pulse Code Modulation (DPCM) with respect to sinusoidal coding (SSC).

The tracking is a process for finding continuation sinusoidal signals between sinusoidal signals included in previous and subsequent frames and establishing correlation between the found continuation sinusoidal signals. Referring to FIG. 3, each point marked with \hat{x} is a sinusoid on a frequency of an axis y in each frame of an axis x, and each line between the \hat{x} marked points is a result obtained by tracking a sinusoidal signal of each frame.

A sinusoid of a current frame, which cannot be tracked from sinusoids of a previous frame, is referred to as a birth sinusoid or a birth partial. The term “birth” means that a sinusoid is not continuous from a sinusoid of a previous frame but is newly born in the current frame. Referring to FIG. 3, \hat{x} marked points 350, 360, and 370 are birth sinusoidal signals. It is determined whether \hat{x} marked points 310, 320, 330, and 340 are birth sinusoidal signals from the relationship between the current frame and the previous frame. For the birth sinusoidal signal, difference coding using a sinusoidal signal of the previous frame cannot be performed, and absolute coding must be performed. Thus, a large number of bits are necessary for coding.

Meanwhile, a sinusoid of the current frame, which can be tracked from the sinusoidal signal of the previous frame, is referred to as a continuation sinusoidal signal or a continuation partial. For example, \hat{x} marked points 351, 352, and 353 are continuation sinusoidal signals that are continuous from a \hat{x} marked point 350. Since the difference coding of the continuation sinusoidal signal can be performed by using the corresponding sinusoidal signal of the previous frame, efficient coding can be performed. The difference coding can reduce bit rate more than the absolute coding, by using the correlation between sinusoidal entropy components (frequency, amplitude, and phase).

Continuation sinusoids mean that sinusoids are continuous with each other. In this case, since sinusoids share continuous information, it is possible to predict another sinusoid using information on one sinusoid, thereby efficiently coding data.

It can be determined whether sinusoids are continuous with each other by using a frequency difference between the sinusoids, or by using the frequency difference and an amplitude ratio between the sinusoids. When (i) the frequency difference is used, it may be determined that two sinusoids are continuous with each other when a frequency difference between the two sinusoids is below a predetermined value. For example, if 0.4 equivalent rectangular bandwidth (ERB) is selected as the predetermined value, if the frequency difference between the two sinusoids is below 0.4 ERB, the two sinusoids are determined to be continuous with each other. Meanwhile, when (ii) the frequency difference and the amplitude ratio are used, it may be determined that two sinusoids are continuous with each other when the frequency difference and the amplitude ratio between the two sinusoids are below a predetermined value. For example, if 0.4 equivalent rectangular bandwidth (ERB) is selected as the frequency difference predetermined value and ⅓-3 times is selected as the amplitude ratio range, if the frequency difference is below 0.4 ERB, and an amplitude value of a current sinusoid is between ⅓ and 3 times an amplitude value of a previous sinusoid, the two sinusoids may be determined to be continuous with each other.

A sinusoid from among continuation sinusoids, which is not continuous with a sinusoid of a subsequent frame and disappears, is referred to as a death sinusoidal signal or a death partial. Referring to FIG. 3, \hat{x} marked points 353 and 314 are death sinusoidal signals.

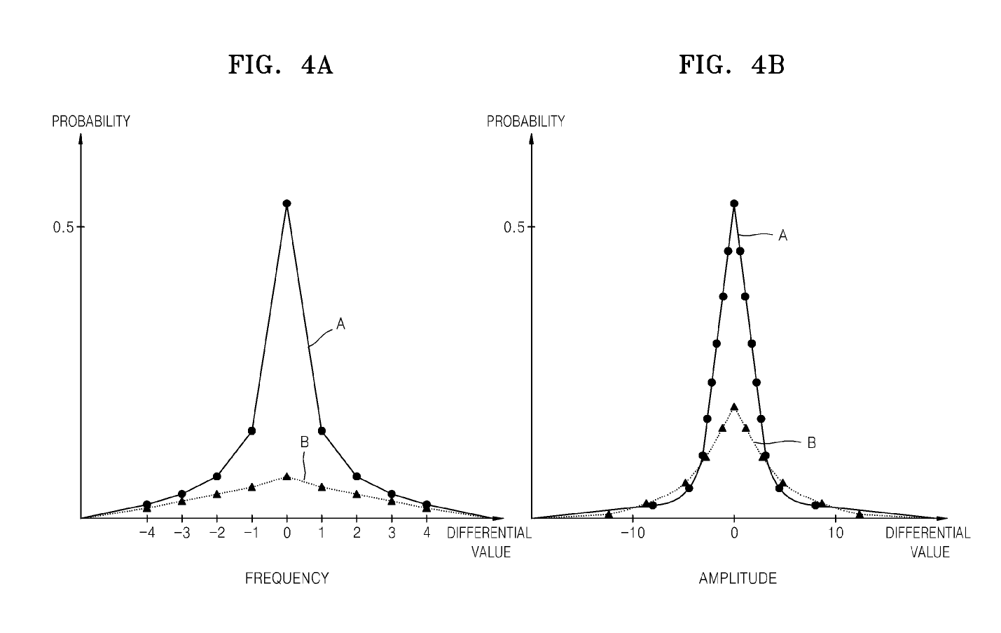

FIGS. 4A and 4B are graphs illustrating a distribution probability of an entropy component in a continuation sinusoidal signal of a current frame based on information on a sinusoidal signal of a previous frame, which is connected to the sinusoidal signal of the current frame, according to an exemplary embodiment of the present invention.

Specifically, FIG. 4A is a graph illustrating a distribution probability of a frequency component, and FIG. 4B is a graph illustrating a distribution probability of an amplitude component.

FIGS. 4A and 4B illustrate characteristics of the continuation sinusoidal signal that has a tendency similar to that of the sinusoidal signal of the previous frame to which it is connected.

In more detail, a component value of the continuation sinusoidal signal does not greatly vary compared to that of the sinusoidal signal of the previous frame to which it is connected in a section where a signal does not greatly vary. In addition, a component value of a continuation sinusoidal signal greatly varies compared to that of the sinusoidal signal of the previous frame to which it is connected in a section where a signal greatly varies.

Due to the characteristics of the continuation sinusoidal signal, the component value of the continuation sinusoidal signal is encoded using a differential value between the continuation sinusoidal signal and the sinusoidal signal of the previous frame. The differential value is small in the section where the component value of the sinusoidal signal does not greatly vary, whereas the differential value is large in the section where the component value of the sinusoidal signal greatly varies.

The above characteristics of the continuation sinusoidal signal will now be described with reference to FIGS. 4A and 4B.

The graphs of FIGS. 4A and 4B include component values to be encoded and distribution probabilities of component values in several continuation sinusoidal signals of a series of frames. The component values to be encoded are the differential values. In particular, when a continuation sinusoidal signal to be encoded in the previous frame has values −1, 0, and 1 and other values, the graphs show a component value to be encoded of a continuation sinusoidal signal of a subsequent frame. An axis x is a differential value for DPCM or ADPCM coding. An axis y is a probability.

For example, a curve A shown in FIG. 4A indicates the component value to be encoded of the continuation sinusoidal signal of the subsequent frame when a component to be encoded of the continuation sinusoidal signal of the previous frame has a value −1, 0, and 1, whereas a curve B shown in FIG. 4A indicates the component value to be encoded of the continuation sinusoidal signal of the subsequent frame when the component to be encoded of the continuation sinusoidal signal of the previous frame has a value other than −1, 0, and 1.

In the curve A, i.e., when the component to be encoded of the continuation sinusoidal signal of the previous frame has the value −1, 0, and 1, the component value to be encoded of the continuation sinusoidal signal of the subsequent frame is frequently near 0 in terms of both frequency and amplitude.

Meanwhile, in the curve B. i.e., when the component to be encoded of the continuation sinusoidal signal of the previous frame has a value other than the value −1, 0, and 1, the component value to be encoded of the continuation sinusoidal signal of the subsequent frame is not relatively near 0 but is widely distributed.

When the component to be encoded of the continuation sinusoidal signal of the previous frame has a small value, the component to be encoded of the continuation sinusoidal signal of the subsequent frame also probably has a small value, whereas, when the component to be encoded of the continuation sinusoidal signal of the previous frame has a large value, the component to be encoded of the continuation sinusoidal signal of the subsequent frame also probably has a large value in the section where a signal greatly varies.

Therefore, information to be encoded of the continuation sinusoidal signal of the previous frame can be used to predict the continuation sinusoidal signal of the subsequent frame to some degree. The present invention provides a method of encoding a continuation sinusoidal signal of a current frame by using a smaller number of bits based on the above principle.

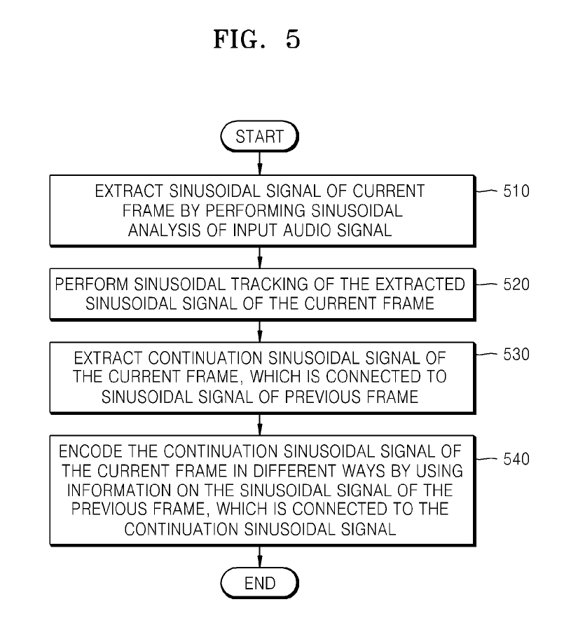

FIG. 5 is a flowchart illustrating an audio signal encoding method according to an exemplary embodiment of the present invention. Referring to FIG. 5, the audio signal encoding method comprises extracting a sinusoidal signal of a current frame by performing a sinusoidal analysis of an input audio signal (operation 510); performing sinusoidal tracking of the extracted sinusoidal signal of the current frame (operation 520); extracting a continuation sinusoidal signal of the current frame, which is connected to a sinusoidal signal of a previous frame (operation 530); and encoding the continuation sinusoidal signal of the current frame in a different way by using information on the sinusoidal signal of the previous frame, which is connected to the continuation sinusoidal signal (operation 540).

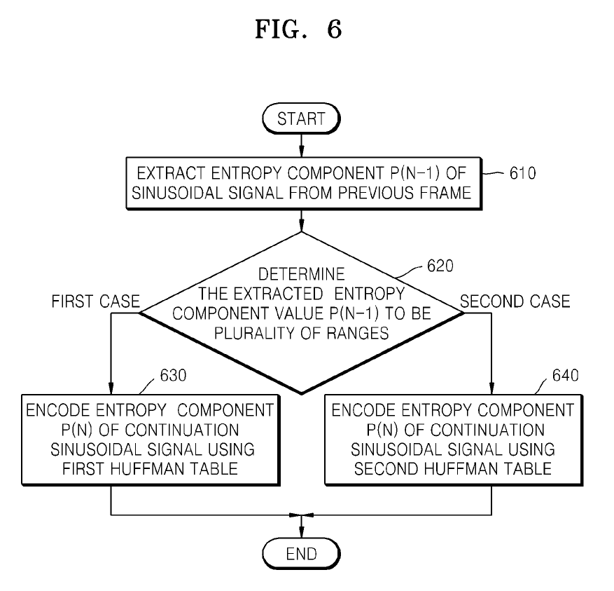

Operation 540 may comprise extracting an entropy component included in the sinusoidal signal of the previous frame, which is connected to the continuation sinusoidal signal; determining a value of the extracted entropy component that is divided into a plurality of ranges; and encoding the continuation sinusoidal signal of the current frame in different ways corresponding to the plurality of ranges. This will be described later with reference to FIG. 6.

In more detail, the sinusoidal analysis of the input audio signal is performed and the sinusoidal signal of the current frame is extracted in operation 510.

The sinusoidal tracking of the extracted sinusoidal signal of the current frame is performed in operation 520. An extraction of a continuation sinusoidal signal of the current frame, which is connected to the sinusoidal signal of the previous frame, is performed in operation 530.

As described above, the correlation between the continuation sinusoidal signal of the previous frame and the continuation sinusoidal signal of the current frame is used to encode the continuation sinusoidal signal of the current frame in different ways in operation 540.

In more detail, when a component to be encoded of the continuation sinusoidal signal of the previous frame has a small value, it is highly probable that a component to be encoded of the continuation sinusoidal signal of the current frame has a small value. When the component to be encoded of the continuation sinusoidal signal of the previous frame has a large value, it is highly probable that the component to be encoded of the continuation sinusoidal signal of the current frame has a large value. Based on the above fact, the continuation sinusoidal signal of the current frame is encoded using different Huffman tables constructed for the above cases.

FIG. 6 is a flowchart illustrating an operation of encoding the continuation sinusoidal signal in different ways by performing operations from among the operations included in the audio signal encoding method according to an exemplary embodiment of the present invention. Referring to FIG. 6, when an n^{th} frame is currently to be encoded, an entropy component P(n−1) of a sinusoidal signal is extracted from a previous frame (n−1^{st} frame) (operation 610). The entropy component may be a frequency, phase, or amplitude of a sinusoidal signal.

The extracted entropy component value P(n−1) is divided into a plurality of ranges and the divided values are determined (operation 620). For example, as mentioned above, the extracted entropy component value P(n−1) may be divided into a range of values −1, 0, and 1 and another range of values other than −1, 0, and 1. It is obvious that the extracted entropy component value P(n−1) may be divided into more than the above two ranges.

The extracted entropy component value P(n−1) is determined as being in two cases in operation 620. In a first case, the extracted entropy component value P(n−1) may be −1, 0, and 1. In a second case, the extracted entropy component value P(n−1) may be a value other than −1, 0, and 1.

In the first case, i.e., when the extracted entropy component value P(n−1) is −1, 0, and 1, an entropy component P(n) of a continuation sinusoidal signal of a current frame (an n^{th} frame) is encoded using a first Huffman table (operation 630).

In the second case, i.e., when the extracted entropy component value P(n−1) is a value other than −1, 0, and 1, the entropy component P(n) of the continuation sinusoidal signal of the current frame is encoded using a second Huffman table (operation 640).

For instance, when the entropy component to be encoded has values 0, 0, 2, 3, 1, 0, −1, and 0 per frame, these values are sequentially encoded below.

(i) When there is no previous frame, the first value 0 may be encoded using any one of the first and second Huffman tables. Alternatively, a Huffman table other than the first and second Huffman tables may be used to encode the first value 0.

(ii) The second value 0 is encoded using the first Huffman table.

(iii) The third value 2 is encoded using the first Huffman table.

(iv) The fourth value 3 is encoded using the second Huffman table.

(v) The fifth value 1 is encoded using the second Huffman table.

(vi) The sixth value 0 is encoded using the first Huffman table.

(vii) The seventh value −1 is encoded using the first Huffman table.

(viii) The eighth value 0 is encoded using the first Huffman table.

The above process is applied in the same manner to the decoding of the encoded bitstream audio signal.

In the encoding operation, the optimal first and second Huffman tables can be used for an occurrence probability of each symbol with regard to the first and second cases. In more detail, different optimal variable length code (VLC) tables are used according to the determination result in operation 620.

Although Huffman coding using the Huffman tables is used in the present exemplary embodiment, arithmetic coding having different probability values may be used instead of the Huffman coding according to the determination result in operation 620. Arithmetic coding, which is a kind of entropy coding for approaching the maximum compression rate, converts continuous data symbols into a decimal value and calculates an optimal decimal bit necessary for presenting each symbol. In addition, adaptive arithmetic coding that adaptively enhances arithmetic coding can be used.

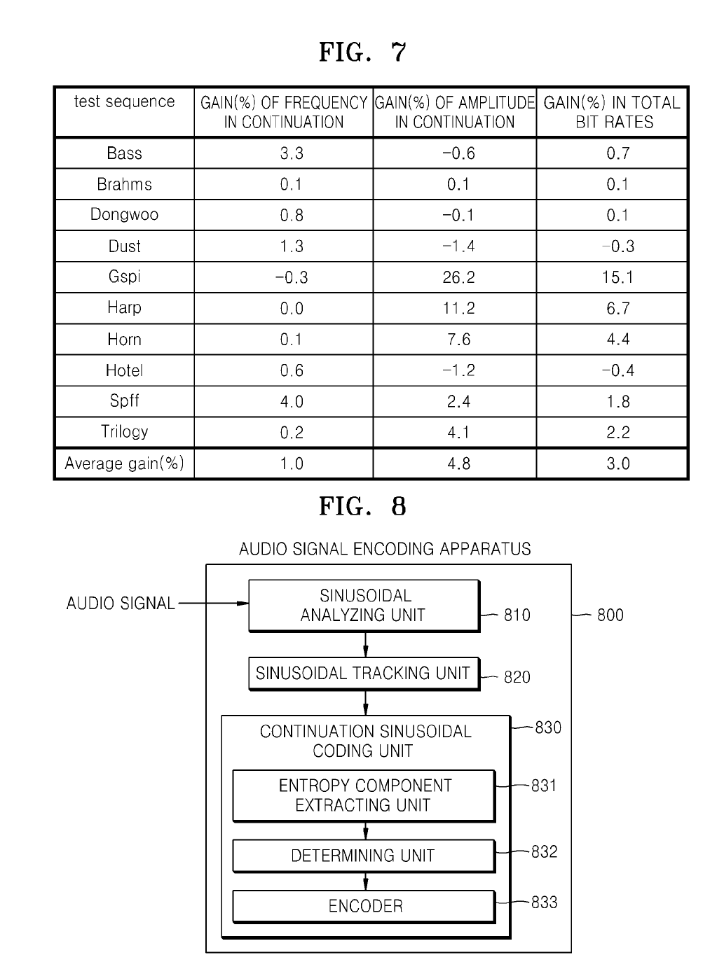

FIG. 7 is a table showing a gain in the number of bits compared to the related art when an audio signal encoding method is applied according to an exemplary embodiment of the present invention.

The gain is a rate of the number of reduced bits after coding is performed. For example, a gain of 3.3% means that the number of bits is reduced by 3.3%.

In order to obtain the results shown in the table of FIG. 7, a bit rate bit_rate_1 is measured when a frequency and amplitude of a sinusoidal signal of a current frame are encoded by applying a related art method of using a single fixed Huffman table.

According to the exemplary embodiment with reference to FIG. 6, the first and second Huffman tables in which a different occurrence probability is assigned to each symbol to be encoded are used to measure the bit rate bit_rate_2 when the sinusoidal signal of the current frame is encoded.

The gain shown in the table is calculated according to equation 1 below.

Gain(%)=(bit_rate_{—}1−bit_rate_{—}2)/(bit_rate_{—}1)*100(%) (1)

The test was conducted using 10 test sequences (Bass, Brahms, Dongwoo, Dust, Gspi, Harp, Horn, Hotel, Spff, and Trilogy).

A first category “Gain of frequency in Continuation” is a rate of the number of reduced bits when a frequency component of the continuation sinusoidal signal is encoded. The table shows that the bit rate is reduced by 1.0% on average compared to the related art method.

A second category “Gain of amplitude in Continuation” is a rate of the number of reduced bits when an amplitude component of the continuation sinusoidal signal is encoded. The table shows that the bit rate is reduced by 4.8% on average compared to the related art method.

A third category “Gain in total bit rate” is a rate of the number of reduced bits when the continuation sinusoidal signal is wholly encoded in each test sequence. The table shows that the bit rate is reduced by 3.0% on average compared to the related art method.

FIG. 8 is a block diagram of an audio signal encoding apparatus 800 according to an exemplary embodiment of the present invention. Referring to FIG. 8, the audio signal encoding apparatus 800 comprises a sinusoidal analyzing unit 810 that performs a sinusoidal analysis of an input audio signal and extracts a sinusoidal signal of a current frame; a sinusoidal tracking unit 820 that performs sinusoidal tracking of the extracted sinusoidal signal of the current frame and extracts a continuation sinusoidal signal of the current frame, which is connected to a sinusoidal signal of a previous frame; and a continuation sinusoidal coding unit 830 that encodes the continuation sinusoidal signal in different ways based on information on the sinusoidal signal of the previous frame, which is connected to the continuation sinusoidal signal.

The continuation sinusoidal coding unit 830 comprises an entropy component extracting unit 831 that extracts an entropy component included in the sinusoidal signal of the previous frame, which is connected to the continuation sinusoidal signal; a determining unit 832 that divides a value of the extracted entropy component into a plurality of ranges and determines the divided value; and an encoder 833 that codes the continuation sinusoidal signal of the current frame in different ways corresponding to the plurality of ranges according to a result of the determination.

Examples of the encoder 833 are advanced audio coding (AAC), MPEG1 audio layer-3 (MP3), windows media audio (WMA), bit sliced arithmetic coding (BSAC) or the like.

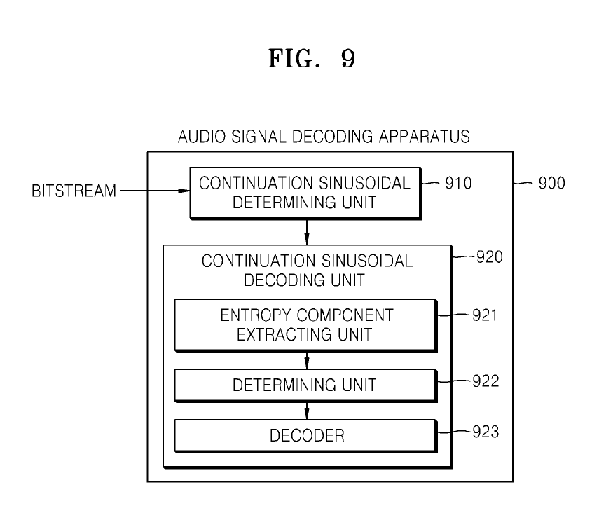

FIG. 9 is a block diagram of an audio signal decoding apparatus 900 according to an exemplary embodiment of the present invention. Referring to FIG. 9, the audio signal decoding apparatus 900 comprises a continuation sinusoidal signal determining unit 910 that determines whether an input bitstream includes a continuation sinusoidal signal of a current frame, which is connected to a sinusoidal signal of a previous frame; and a continuation sinusoidal decoding unit 920 that, when the input bitstream is determined to include the continuation sinusoidal signal, decodes the continuation sinusoidal signal in different ways based on information on a decoded sinusoidal signal of the previous frame, which is connected to the continuation sinusoidal signal.

The continuation sinusoidal decoding unit 920 comprises an entropy component extracting unit 921 that extracts an entropy component included in the sinusoidal signal of the previous frame, which is connected to the continuation sinusoidal signal; a determining unit 922 that divides a value of the extracted entropy component into a plurality of ranges and determines the divided value; and a decoder 923 that codes the continuation sinusoidal signal of the current frame in different ways corresponding to the plurality of ranges according to a result of the determination.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc.

The invention can also be embodied as computer readable codes transmitted on a computer readable transmission medium. The computer readable transmission medium is any transmission medium in which data can be transmitted which can be thereafter read by a computer system. Examples of a computer readable transmission medium include carrier waves (such as data transmission through the Internet), etc.

A method and apparatus for encoding a continuation sinusoidal signal of an audio signal according to the present invention apply optimal entropy coding to the continuation sinusoidal signal of a current frame according to a value of an entropy component included in a sinusoidal signal of a previous frame using the characteristics of the continuation sinusoidal signal, thereby efficiently encoding the audio signal with a relatively small number of bit rates. The effect of a reduction in bit rates according to the audio signal encoding method of the present invention was described in detail with reference to FIG. 7 and compared to the related art.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An audio signal encoding method comprising:
extracting a sinusoidal signal of a current frame by performing sinusoidal analysis on an input audio signal;
extracting a continuation sinusoidal signal of the current frame, which is connected to a sinusoidal signal of a previous frame, by performing sinusoidal tracking of the extracted sinusoidal signal of the current frame; and
encoding the continuation sinusoidal signal by using information on the sinusoidal signal of the previous frame, which is connected to the continuation sinusoidal signal.

2. The audio signal encoding method of claim 1, wherein the encoding of the continuation sinusoidal signal comprises:
extracting an entropy component included in the sinusoidal signal of the previous frame, which is connected to the continuation sinusoidal signal;
dividing a value of the extracted entropy component into a plurality of ranges and determining the divided value; and
encoding the continuation sinusoidal signal of the current frame based on the plurality of ranges according to a result of the determination.

3. The audio signal encoding method of claim 2, wherein a Huffman table or arithmetic coding is used to encode the continuation sinusoidal signal of the current frame, and
wherein different Huffman tables or different arithmetic probability values are used according to the plurality of ranges.

4. The audio signal encoding method of claim 3, wherein the value of the extracted entropy component is determined to be in the ranges of 0 and values other than 0 or in the ranges between −1 and 1 and values other than between −1 and 1.

5. The audio signal encoding method of claim 4, wherein the extracted entropy component is at least one of a frequency, phase, and amplitude.

6. An audio signal encoding apparatus comprising:
a sinusoidal analyzing unit which performs sinusoidal analysis of an input audio signal and extracts a sinusoidal signal of a current frame;
a sinusoidal tracking unit which performs sinusoidal tracking of the extracted sinusoidal signal of the current frame and extracts a continuation sinusoidal signal of the current frame, which is connected to a sinusoidal signal of a previous frame; and
a continuation sinusoidal coding unit which encodes the continuation sinusoidal signal based on information on the sinusoidal signal of the previous frame, which is connected to the continuation sinusoidal signal.

7. The audio signal encoding apparatus of claim 6, wherein the continuation sinusoidal coding unit comprises:
an entropy component extracting unit which extracts an entropy component included in the sinusoidal signal of the previous frame, which is connected to the continuation sinusoidal signal;
a determining unit which divides a value of the extracted entropy component into a plurality of ranges and determines the divided value; and
an encoder which codes the continuation sinusoidal signal of the current frame based on the plurality of ranges according to a result of the determination.

8. The audio signal encoding apparatus of claim 7, wherein the encoder encodes the continuation sinusoidal signal of the current frame using a Huffman table or arithmetic coding, and
wherein different Huffman tables or different arithmetic probability values are used according to the plurality of ranges.

9. The audio signal encoding apparatus of claim 8, wherein the determining unit determines the value of the extracted entropy component in the ranges of 0 and values other than 0 or in the ranges between −1 and 1 and values other than between −1 and 1.

10. A method of decoding an audio signal that is input as a bitstream comprising:
determining whether the input bitstream includes a continuation sinusoidal signal of a current frame, which is connected to a sinusoidal signal of a previous frame; and
when the input bitstream is determined to include the continuation sinusoidal signal, decoding the continuation sinusoidal signal based on information on a decoded sinusoidal signal of the previous frame, which is connected to the continuation sinusoidal signal.

11. The method of claim 9, wherein the determining comprises:
extracting an entropy component included in the sinusoidal signal of the previous frame, which is connected to the continuation sinusoidal signal;
dividing a value of the extracted entropy component into a plurality of ranges and determining the divided value; and
decoding the continuation sinusoidal signal of the current frame based on the plurality of ranges according to a result of the determination.

12. The method of claim 11, wherein a Huffman table or arithmetic coding is used to decode the continuation sinusoidal signal of the current frame, and
wherein different Huffman tables or different arithmetic probability values are used according to the plurality of ranges.

13. The method of claim 12, wherein the value of the extracted entropy component is determined to be in the ranges of 0 and values other than 0 or in the ranges between −1 and 1 and values other than between −1 and 1.

14. The method of claim 13, wherein the extracted entropy component is at least one of a frequency, phase, and amplitude.

15. An apparatus for decoding an audio signal that is input as a bitstream comprising:
a continuation sinusoidal signal determining unit which determines whether an input bitstream includes a continuation sinusoidal signal of a current frame, which is connected to a sinusoidal signal of a previous frame; and
a continuation sinusoidal decoding unit which, when the input bitstream is determined to include the continuation sinusoidal signal, decodes the continuation sinusoidal signal based on information on a decoded sinusoidal signal of the previous frame, which is connected to the continuation sinusoidal signal.

16. The apparatus of claim 15, wherein the continuation sinusoidal decoding unit comprises:
an entropy component extracting unit which extracts an entropy component included in the sinusoidal signal of the previous frame, which is connected to the continuation sinusoidal signal;
a determining unit which divides a value of the extracted entropy component into a plurality of ranges and determines the divided value; and
a decoder which decodes the continuation sinusoidal signal of the current frame based on the plurality of ranges according to a result of the determination.

17. The apparatus of claim 16, wherein the decoder decodes the continuation sinusoidal signal of the current frame using a Huffman table or arithmetic coding,
wherein different Huffman tables or different arithmetic probability values are used according to the plurality of ranges.

18. The apparatus of claim 17, wherein the determining unit determines the value of the extracted entropy component in the ranges of 0 and values other than 0 or in the ranges between −1 and 1 and values other than between −1 and 1.
